(19) United States
(12) Patent Application Publication
(10) Pub. No.: US 2023/0328809 A1
(43) Pub. Date: Oct. 12, 2023

(54) METHOD FOR ADDING A COMMUNICATING OBJECT TO A WIRELESS COMMUNICATION NETWORK

(71) Applicant: Orange, Issy-Les-Moulineaux (FR)

(72) Inventors: Kévin L'HEREEC, Chatillon Cedex (FR); Arnaud RUFFIN, Chatillon Cedex (FR)

(21) Appl. No.: 18/296,683

(22) Filed: Apr. 6, 2023

(30) Foreign Application Priority Data
Apr. 8, 2022 (FR) 2203239

(51) Int. Cl. H04W 76/10; H04W 48/16; H04W 48/08; H04W 72/0453

(52) U.S. Cl. CPC H04W 76/10; H04W 48/16; H04W 88/16; H04W 72/0453; H04W 48/08

(57) ABSTRACT

A method for adding a communicating object to a wireless communication local network provided by a gateway, the method being implemented within a dedicated application executed on a communication terminal connected to the network via the gateway. The method includes: emitting, to the gateway, a request for obtaining at least one piece of information on connection to the network; receiving, from the gateway, the at least one piece of information on connection to the network; and transmitting, to the communicating object, the at least one piece of information on connection to the network.

### CROSS-REFERENCE TO RELATED APPLICATIONS

The application claims foreign priority to French Patent Application No. FR 2203239, entitled “METHOD FOR ADDING A COMMUNICATING OBJECT TO A WIRELESS COMMUNICATION NETWORK” and filed Apr. 8, 2022, the content of which is incorporated by reference herein in its entirety.

### BACKGROUND

### Technical Field

The development relates to the field of Internet of Things. More particularly, the development relates to techniques allowing adding a communicating object to an existing wireless communication local network, for example a WiFi network.

### Related Art

The market of communicating objects—i.e. objects provided with means for connecting to a communication network, for example a local network and/or the Internet network—is booming. This market is driven in particular by the home automation field, users now having a wide range of communicating objects (connected sockets, connected bulbs, connected rolling shutters, connected cameras, connected loudspeakers, connected heaters, connected smoke detectors, etc.) that they can add to the local network of their home in order to be able to remotely monitor these pieces of equipment (via a smartphone or a tablet for example), make them communicate with each other, integrate them to automated scenario, receive warning notifications, etc. This increasing integration of communicating objects within a home, most often connected to the Internet network, pertains to the “smart home” (or “connected home”) concept, which allows addressing many aspirations of users, in terms of comfort, security, energy efficiency, etc.

Among communicating objects available on the market, a larger number is based on wireless communication protocols, in particular protocols according to the IEEE 802.11 standard (i.e. the WiFi technology), to enable connection thereof to the network. This is explained by the fact that wireless networks, such as WiFi wireless networks are widely deployed in a very large number of local and domestic networks, because of their simple use (wireless connection of the equipment) associated with the increasing access of households to gateways (for example in the form of “set-top box”) integrating these technologies by default.

Nonetheless, while the use of a communicating object connected to a wireless network is generally simple and intuitive on a daily basis, it is still conditional on the prior implementation of a step of adding this communicating object to the existing network. This process—also sometimes referred to as pairing—consists in providing the communicating object, before first use thereof, with the information enabling it to connect to the network of the user, generally provided by a domestic gateway. This connection information typically comprises the name of the network to which the communicating object should connect and, in most cases, an associated password the knowledge of which is required by the gateway to authorise the connection. Yet, a large number of current communicating objects have no keyboard or screen, and therefore are not provided with means allowing entering this connection information. Thus, the user generally has to resort to a dedicated application installed on a more sophisticated communication terminal, for example a smartphone, in order to enter this information and transmit it to the communicating object.

However, as explained hereinafter, such operations may sometimes turn out to be complex and unintuitive to implement for a non-informed user, in particular for the general public which however forms the core of the public targeted by these products.

Firstly, the manual input of the connection information on the communication terminal of the user is often tedious and error-prone, which might generate some frustration with the user.

Secondly, even when this information has been properly input by the user in the application dedicated to this end, their transmission from the communication terminal to the communicating object may turn out to be more complex than expected, and require the user to perform some operations of setting his communication terminal and/or the gateway providing the WiFi network. In such a situation, the user generally has no other choice than quitting the application dedicated to the addition of a communicating object to the network, to browse in the administration screens of the gateway and/or the system screens for setting the parameters of his communication terminal, in order to modify at least temporarily the configuration of these pieces of equipment for the time of the pairing.

It goes without saying that such manipulations imply a complex and unintuitive procedure for most users. Not only the user experience is degraded, but there is also an increased risk that the user performs wrong setting choices of his communication terminal or of his gateway, likely to jeopardise proper operation.

Solutions have been developed in an attempt to facilitate the process of pairing a WiFi communicating object to a WiFi network (for example WPS, standing for “Wi-Fi Protected Setup”, “Easy Connect™”, transmission of the connection information by Bluetooth). However, all these existing solutions impose a specific design of the WiFi communicating object (for example the presence of additional communication interfaces in addition to the WiFi interface, and/or the support of communication protocols other than the WiFi protocol), for it to be compatible with the proposed pairing techniques. Hence, these solutions are not universal, and also imply an increase in the production costs of the communicating objects integrating them.

Hence, there is a need for a universal solution allowing simplifying the user experience during the addition of a new WiFi communicating object to an existing WiFi network.

### SUMMARY

The present technique allows proposing a solution intended to overcome some drawbacks of the prior art. Indeed, according to one aspect, the present technique relates to a method for adding a communicating object to a wireless communication local network provided by a gateway, said method being implemented within a dedicated application executed on a communication terminal connected to said network via said gateway. This method comprises:
emitting, to said gateway, a request for obtaining at least one piece of information on connection to said network;
receiving, from said gateway, said at least one piece of information on connection to said network;
transmitting, to said communicating object, said at least one piece of information on connection to said network.

In this manner, obtaining the connection information to be communicated to the communicating object for the latter to be able to connect to the wireless communication local network is performed automatically, this information being recovered directly before the gateway, upon request of the communication terminal. Hence, the user no longer needs to manually enter this information on his communication terminal through a tedious and error-prone operation. Thus, the addition of the communicating object to the wireless communication network is simplified, and the user experience improved.

In a particular embodiment, the method comprises, prior to said transmission, a step of emitting, to said gateway, at least one request for implementing by said gateway at least one operation amongst a frequency deactivation operation and a frequency scan operation, said request comprising at least one piece of information on the frequency band concerned by said operation.

In this manner, the proposed technique allows requesting the gateway to implement an operation intended to favour the transmission of the connection information obtained by the communication terminal to the communicating object, without quitting the application dedicated to the addition of a communicating object to the wireless communication network. Thus, the gateway is asked to implement a frequency deactivation and/or frequency scan operation allowing favouring the selection of a frequency band suited for this transmission, either by deactivation of the frequency bands unsuitable for such a transmission, or by transmission of a piece of information to the communication terminal enabling it to more easily detect the communicating object in a frequency band suited for this transmission.

According to a particular feature, said request for obtaining at least one piece of information on connection to the network, said request for implementing a frequency deactivation operation, and said request for implementing a frequency scan operation are respectively formatted in accordance with first, second and third application programming interfaces exposed by said gateway for the supply of corresponding services to said communication terminal.

In this manner, the resort to the gateway by the communication terminal is guided and secure. Only some services well identified are proposed and made available to third-party devices by the gateway, via corresponding application programming interfaces. Thus, access to these services requires these third-party devices being on the one hand connected to the communication network provided by the gateway, and on the other hand, that they know the modalities of access to these services, i.e. the formalism or the way of interrogating the gateway via right requests allowing access thereto.

According to a particular feature, said transmission is implemented by disseminating said connection information, and said method comprises, prior to said transmission, emitting, to said gateway, a request for deactivating at least one first frequency band at the level of said gateway, said deactivation causing an automatic toggling of said communication terminal into a communication mode using a second frequency band other than said at least one first deactivated first frequency band at the level of said gateway, for said transmission by dissemination.

In this manner, without quitting the application for adding a communicating object, it is possible to automatically force the communication terminal to communicate in a frequency band supported by the communicating object for the transmission of the connection information. Thus, the user is relieved from having to carry out, prior to such a transmission, manual and risky modifications of the configuration of the gateway via administration interfaces often very technical and abstruse. Thus, the addition of the communicating object to the wireless communication network is further simplified, and the user experience is further improved.

According to a particular feature of this embodiment, said request for deactivating at least one first frequency band is a request for deactivating at least one amongst the frequency bands 5 GHz and 6 GHz.

In this manner, the frequency band over which a communicating object is most unlikely able to communicate are deactivated, resulting de facto in toggling of the communication terminal into the frequency band 2.4 GHz usually used by most communicating objects available on the market.

According to a particular feature of this embodiment, the method comprises, subsequently to said transmission, emitting, to said gateway, a request for reactivating, at the level of said gateway, said at least one first frequency band deactivated beforehand.

In this manner, the initial configuration of the gateway is re-established once the addition of the communicating object to the wireless communication network is completed.

According to another particular embodiment, said transmission of said connection information is implemented by means of a direct communication channel established between said communication terminal and said communicating object configured beforehand as an access point, and said method comprises, prior to said transmission:
emitting, to said gateway, a network scan request;
receiving, from said gateway, a list of networks detected by said gateway during said network scan;
selecting, within said list, a network corresponding to the network associated to said communicating object configured as an access point;
establishing said direct communication channel between said communication terminal and said communicating object, by connection of the communication terminal to said selected network.

In this manner, the identification of the wireless communication network by the communicating object configured as an access point is facilitated, and the connection of the communication terminal to this network is implemented directly from the application dedicated to the addition of a communicating object to a wireless communication network, without the user having to browse in the native screens and the system parameters of the communication terminal. Thus, the addition of the communicating object to the wireless communication network is further simplified, and the user experience is further improved.

According to a particular feature of this embodiment, said network scan request comprises a frequency band piece of information to be used for said network scan.

In this manner, it is possible to limit the list of detected networks to networks having the highest probability of corresponding to a network generated by a communicating object. Thus, the identification of the wireless communication network provided by the communicating object configured as an access point is further facilitated.

According to a particular feature of this embodiment, the method comprises identifying, within said list of detected networks, at least one network whose name meets the criteria of a predetermined name mask stored in said dedicated application; and, when said identification step delivers a unique result, the automatic selection of said network identified in a unique way.

In this manner, the identification of the wireless communication network provided by the communicating object configured as an access point, then the connection of the communication terminal to this network, may be performed in a fully automatic and transparent manner for the user. Thus, the addition of the communicating object to the wireless communication network is further simplified, and the user experience is further improved.

According to a particular feature of this embodiment, said list comprises a receive power level indicative value associated to each detected network.

In this manner, the distance of a communicating object to the gateway may be estimated and used to further facilitate the identification of the wireless communication network provided by the communicating object configured as an access point.

According to a particular feature of this embodiment, said steps of emitting a network scan request and of receiving a list of networks in response to said scan request are implemented at least twice, and the method comprises:
displaying, between two iterations of said steps of emitting a network scan request and of receiving a list of networks in response to said scan request, an invitation to bring said communicating object away from or lose to said gateway;
comparing, for each detected network, receive power level indicative values obtained during each of said iterations;
automatically selecting or highlighting within a graphical interface associated to said application, amongst the list of detected networks, according to the result of said comparison, a network having the highest probability of corresponding to the network provided by said communicating object configured as an access point.

In this manner, the receive power level indicative value may be used as an ambiguity clear-up mechanism, to facilitate the identification of the wireless communication network provided by the communicating object configured as an access point, by simply bringing the communicating object close to or away from the gateway.

According to another particular feature of this embodiment, the emission of a network scan request and the reception of a list of networks in response to said scan request are implemented at least twice, and the method comprises:
displaying, between two iterations of said steps of emitting a network scan request and of receiving a list of networks in response to said scan request, an invitation to toggle said communicating object into an access point configuration;
comparing the lists of detected networks during each of said iterations;
automatically selecting or highlighting within a graphical interface associated to said application, amongst the list of detected networks, according to the result of said comparison, a network having the highest probability of corresponding to the network provided by said communicating object configured as an access point.

In this manner, the configuration mode of the communicating object may also be used as an ambiguity clear-up mechanism, to facilitate the identification of the wireless communication network provided by the communicating object configured as an access point, by simply toggling the communicating object from a configuration mode in which it is still not configured as an access point into a configuration mode in which it is configured as an access point.

According to another aspect, the present technique also relates to a communication terminal for the implementation of an addition of a communicating object to a wireless local network provided by a gateway. Such a communication terminal comprises:
means for emitting, to said gateway, a request for obtaining at least one piece of information on connection to said network;
means for receiving, from said gateway, said at least one piece of information on connection to said network;
means for transmitting, to said communicating object, said at least one piece of information on connection to said network.

The means of said terminal may be adapted to the implementation of any one of the embodiments of the method of the present application.

According to still another aspect, the present technique also relates to a gateway for providing a wireless local network, said gateway comprising a set of application programming interfaces for providing at least one service to a communication terminal connected to said network via said gateway, on request of said communication terminal, called requesting terminal, said set of application programming interfaces comprising:
a first application programming interface for obtaining at least one piece of information on connection to said network, and for providing said connection information to said requesting terminal;
a second application programming interface for deactivation/reactivation of at least one frequency band at the level of said gateway;
a third application programming interface for implementing a network scan and for providing said requesting terminal with a list of networks detected during said network scan.

Thus, the gateway for the provision of a wireless communication network comprises means which could be used by a communication terminal to simplify the addition of a communicating object to said network, without requiring any specific design of the communicating object for the implementation of such a simplified addition.

According to another aspect, the proposed technique also relates to a computer program product downloadable from a communication network and/or stored on a computer-readable medium and/or executable by a microprocessor, comprising program code instructions for the execution of a method for adding a communicating object to a wireless communication network as described before, when it is executed on a computer.

The proposed technique also relates to a computer-readable storage medium on which a computer program is stored comprising program code instructions for the execution of the steps of the method as described before, in any one of its embodiments.

Such a storage medium may be any entity or device capable of storing the program. For example, the medium may include a storage means, such as a ROM, for example a CD-ROM or a ROM of a microelectronics circuit, or a magnetic storage means, for example a flash disk or a hard disk.

Besides, such a storage medium may be a transmissible medium such as an electrical or optical signal, which could be conveyed via an electrical or optical cable, by radio waves or by other means, so that the computer program contained therein is remotely executable. In particular, the program according to the development may be downloaded on a network for example the Internet network.

The different above-mentioned embodiments can be combined together for the implementation of the development.

### BRIEF DESCRIPTION OF THE DRAWINGS

Other features and advantages of the development will appear more clearly upon reading the following description of a preferred embodiment, given merely as an illustrative and non-limiting example, and from the appended drawings, wherein:

FIG. 1 illustrates the general principle of a method for adding a communicating object to a wireless communication network, in a particular embodiment of the proposed technique;

FIG. 2 shows a sequence diagram of a particular embodiment of the method for adding a communicating object to a wireless communication network according to the proposed technique;

FIG. 3 shows a sequence diagram of another particular embodiment of the method for adding a communicating object to a wireless communication network according to the proposed technique;

FIG. 4 describes a simplified architecture of a communication terminal for the implementation of the proposed technique, in a particular embodiment;

FIG. 5 shows a simplified diagram of a gateway for the provision of a wireless communication network, in a particular embodiment of the proposed technique.

### DETAILED DESCRIPTION OF CERTAIN EMBODIMENTS

The present application allows overcoming some of the aforementioned drawbacks.

The proposed technique aims in particular to simplify and make the procedure of adding a communicating object to an existing wireless communication local network provided by a gateway-type electronic device more robust. Such an addition, which generally corresponds to the process enabling the first ever connection of a communicating object to an existing wireless network, is sometimes also referred to as “pairing” between the communicating object and the gateway serving as an access point to the wireless network.

In the present document, the proposed technique is essentially disclosed in the context of addition of a WiFi communicating object to an existing WiFi network, i.e. according to communication protocols based on the IEE 802.11 standard. Of course, this example is merely illustrative and non-limiting, and representative of a particular embodiment of the proposed technique. In other words, the present technique may also be implemented for the addition of a communicating object to a wireless network based on wireless communication protocols other than communication protocols according to the IEE 802.11 standard.

As detailed later on, the present technique is particularly advantageous in comparison with the solutions of the prior art in many aspects. First of all, it allows limiting the number of entries to be performed by the user to add a new communicating object to an existing wireless network (for example a WiFi network), hereby reducing de facto the risk of error during such entries. Secondly, it offers the possibility of carrying out the entire process of adding a communicating object to an existing wireless network (for example a WiFi network) within the same application dedicated for this purpose, executed on a communication terminal. More particularly, the present technique significantly simplifies the user experience, by avoiding to the latter having to quit the dedicated application and browse in administration screens or complex system screens to modify the configuration of his communication terminal and/or of his gateway, with all the risks that such modifications include. Thirdly, the proposed technique does not require any modification or specific design of the communicating objects: it is compatible with all types of communicating objects in accordance with the wireless communication protocol on which the considered wireless network is based (and in particular, for example, with the WiFi communicating object compliant with the IEEE 802.11 standard, in the context of implementation of the method for the addition of a WiFi communicating object to a WiFi network), including those already on the market.

In the context of the present document, by “communicating object”, reference is made to an electronic apparatus comprising at least one communication interface enabling it to connect to a communication network, for example a local network or the Internet network, via a predetermined set of wireless communication protocols. For example, by “WiFi communicating object”, reference is made to an electronic apparatus comprising at least one WiFi interface enabling it to connect to a communication network via a set of wireless communication protocols according to the IEEE 802.11 standard.

In all figures of the present document, identical elements and steps bear the same reference numeral.

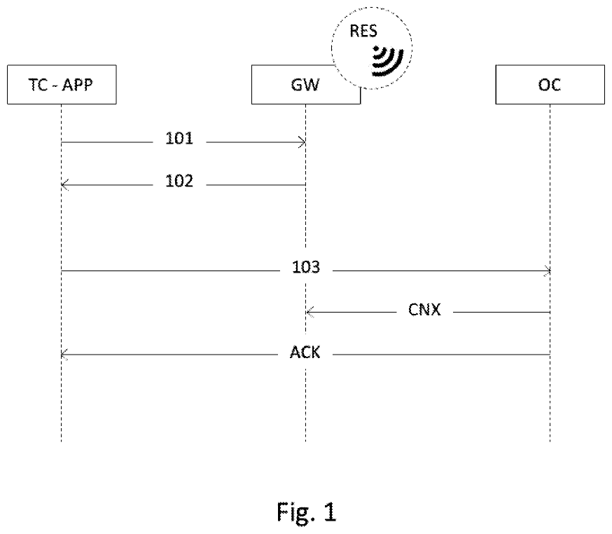

According to a first aspect, the present technique relates to a method for adding a communicating object to a wireless local network. The general principle of such a method is illustrated with reference to FIG. 1, in the illustrative context of the addition of a WiFi communicating object to a WiFi network. The WiFi network RES to which a user wishes to add a communicating object OC is provided by a gateway GW, which therefore serves as an access point to this network RES. The method according to the proposed technique is implemented by a communication terminal TC comprising a WiFi interface, and connected to said network RES. This communication terminal TC also comprises a screen and input means, and is for example in the form of a smartphone, a tablet, a computer, etc. More particularly, the method is implemented via an application APP executed on the communication terminal TC, this application APP comprising at least one module dedicated to the addition of a new WiFi communicating object within a wireless local network. For example, the dedicated application APP is an application pre-installed on the communication terminal TC, or available for download or on a storage medium so as to enable installation thereof on the communication terminal TC. For example, it is made available to the user by a communicating object manufacturer, or by a service provider. As described later on, all of the steps of the method for adding a communicating object to a wireless communication network according to the present technique are implemented by this dedicated application APP (in other words, with the proposed technique, the entirety of the process of adding a communicating object to a wireless network is carried out within this application APP, without the user having to perform manipulations on the communication terminal TC outside this application APP).

In a step 101, the communication terminal TC emits to the gateway GW, a request for obtaining at least one piece of information on connection to the WiFi network RES provided by the gateway GW.

In a step 102, in response to the request emitted at step 101, the communication terminal TC receives from the gateway GW, enough connection information to enable a device having a WiFi interface and this connection information to connect to the network RES provided by the gateway GW. Such connection information comprises at least one identifier of the network RES, typically in the form of a SSID (standing for “Service Set Identifier”, which corresponds to the name of the wireless network), and generally an associated password.

In a step 103, the communication terminal TC transmits this connection information to the communicating object OC, thereby enabling the communicating object OC to establish a connection CNX to the Wifi network RES via the gateway GW. Possibly, once this connection is established, the communicating object OC has the possibility of sending a message ACK confirming success of this connection to the application APP of the communication terminal TC.

Thus, the proposed technique allows relieving the user from a manual and tedious input of information on connection to the WiFi network RES on the communication terminal TC, this information being received directly from the gateway GW by the communication terminal TC already connected to the WiFi network RES, for example by means of a first application programming interface (or API), intended to this end at the level of the gateway GW. Hence, there is no risk of error in entering this information by the user, and the addition of the communicating object OC to the WiFi network RES is thereby simplified.

Step 103 of transmitting to the communicating object OC the connection information obtained at step 102 may be implemented via different techniques conventionally used for this purpose, for example:
by general (i.e. in the “broadcast” mode) or grouped (i.e. in the “multicast” mode) dissemination implemented via the WiFi interface of the communication terminal (WiFi pairing in a mode commonly referred to as “EZ mode”, abbreviation of the word “easy”), and describing a mode in which it is not necessary to establish a point-to-point communication channel between the communication terminal and the communicating object, the communicating object within broadcast range intercepting by itself the data broadcast by the communication terminal);
via a WiFi communication channel established directly with the WiFi communicating object configured beforehand as a WiFi access point (WiFi pairing in a mode commonly referred to as “AP mode”, standing for “Access Point”, and describing a mode in which the communicating object broadcast its own wireless network for which it serves as an access point and to which the communication terminal directly connects to enable a subsequent data transmission between these two pieces of equipment);
possibly by other means, via communication protocols other than WiFi, for example via a Bluetooth or NFC link, when both the communicating object and the communication terminal allow doing so.

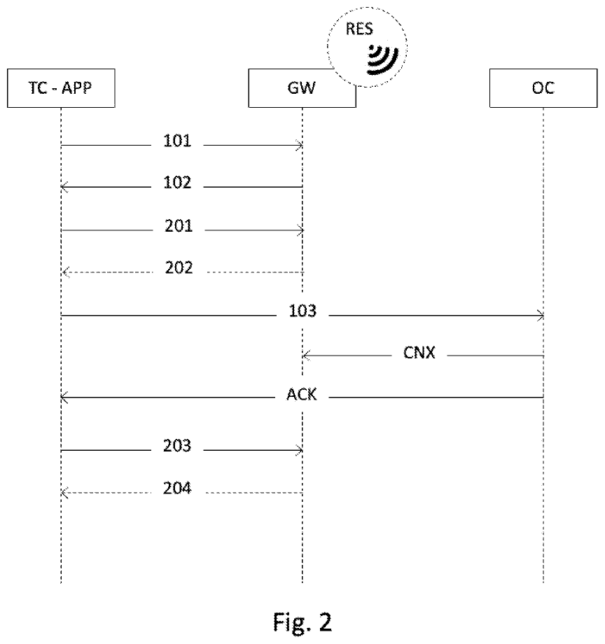

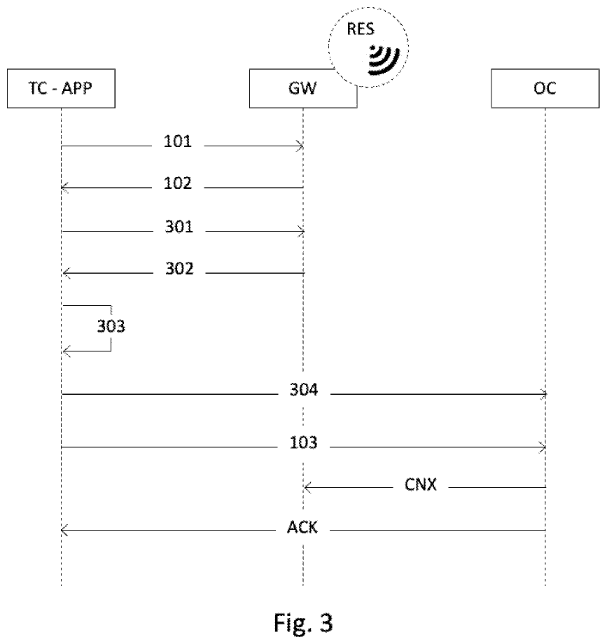

Concerning these aspects, and as described hereinafter with reference to FIGS. 2 and 3, besides the automated and facilitated recovery of the previously-described connection information, the present technique also offers complementary mechanisms intended to simplify and make the transmission of this information from the communication terminal TC to the communicating object OC more robust, in particular when this transmission is implemented by means of the WiFi interfaces of these pieces of equipment (i.e. in the EZ and AP mode).

As detailed later on, a common feature of these mechanisms is a demand, by the communication terminal TC, for example via dedicated application programming interfaces exposed (i.e. made available) by the gateway GW, for the implementation at the level of the gateway GW of at least one operation intended to optimise the transmission of the connection information from the communication terminal TC to the communicating object OC (for example by promoting the selection of a frequency band adequate for this transmission). In particular, according to the implemented embodiment, such an operation may be in the form of an operation of deactivation of some frequencies at the level of the gateway GW, or the implementation of a network scan on some frequencies by said gateway GW.

### First Embodiment—Transmission in the EZ Mode

Firstly, a particular embodiment of the method according to the present technique is described with reference to FIG. 2, wherein step 103 of transmitting the information on connection to the WiFi network RES from the communication terminal TC to the communicating object OC is implemented by general (i.e. in the “broadcast” mode) or grouped (i.e. in the “multicast” mode) dissemination of said connection information, via the WiFi interface of the communication terminal TC (case of a transmission in the EZ mode). Steps 101 and 102 of obtaining the connection information remain identical to those already described with reference to FIG. 1.

In this particular embodiment, before disseminating (i.e. broadcasting in a “broadcast” or “multicast” mode) the connection information, the communication terminal emits, in a step 201, a request for deactivating at least one first WiFi frequency band at the level of the gateway GW (thereby resorting for example to a second application programming interface provided for this purpose at the level of the gateway GW).

As described in more details later on, the emission of such a request is particularly ingenious in that it allows, without any intervention of the user and without quitting the application APP during execution on the communication terminal TC, making the communication terminal TC (most often a multiband one) automatically toggle into a communication mode based on the use of a second WiFi frequency band different from the at least one first WiFi frequency band deactivated at the level of the gateway GW. In this manner, it is thus possible, without quitting the application APP, to force the communication terminal TC to emit in a given WiFi frequency band (i.e. the second frequency band) for the transmission by general or grouped dissemination of the connection information carried out at step 103, and more particularly in the WiFi frequency band used by the communicating object OC. Thus, the user is relieved from tedious and tricky manipulations, generally needed by the solutions of the prior art, for manually modifying the configuration of the gateway via administration interfaces, often very technical and abstruse for the general public, these manipulations consisting for example in manually modifying some parameters of the gateway in order to cut off the frequency bands not supported by the communicating object, or in order to dissociate the frequency bands in which the gateways functions so that the latter broadcast a different network name (SSID) for each of the supported frequency bands and that the user could later on connect his communication terminal to the right network (i.e. that one functioning over a frequency band supported by the communicating object).

As an illustrative and non-limiting example, it could be noticed that most current gateway support both the WiFi frequency band at 2.4 GHz and at least one amongst the WiFi frequency bands at 5 GHz and 6 GHz. Also, according to a particular feature of the present technique, the request for deactivating at least one first frequency band is a demand for deactivating the frequency bands 5 GHz and/or 6 GHz at the level of the gateway GW. Henceforth, once this request is treated, the gateway GW emits only in the WiFi frequency band 2.4 GHz. Without any intervention of the user of the communication terminal and without quitting the application APP dedicated for adding a WiFi communicating object, this results in an automatic toggling of the communication terminal TC into a communication mode based on the use of the second WiFi frequency band 2.4 GHz, according to conventional mechanisms for preserving the WiFi connection between the communication terminal and the gateway. In other words, the communication terminal TC, detecting that its connection to the WiFi network RES is no longer possible over the first WiFi frequency bands 5 GHz and/or 6 GHz, is thus forced to communicate over the second WiFi frequency band 2.4 GHz, which is specifically the frequency band essentially used by most communicating objects available on the market. According to the proposed technique, this toggling is also completely transparent for the user.

Thus, without any intervention of the user and without quitting the dedicated application APP, the communication terminal automatically toggles into a WiFi transmission mode highly probably compatible with the WiFi listen mode used by the communicating object to receive the connection information. Thus, the procedure for adding a communicating object to a WiFi network in the EZ mode is made even simpler and more robust.

According to a particular feature, once the connection information is transmitted to the communicating object OC, the communication terminal TC emits to the gateway GW, in a step 203, a request for reactivating, at the level of said gateway, first frequency bands deactivated beforehand.

Alternatively, the deactivation of the first frequency bands at the level of the gateway GW, upon reception by the gateway GW of the deactivation request emitted at step 201, is associated with a delay time. In this case, the reactivation, by the gateway GW, of the first frequency bands deactivated beforehand is then automatic within a predetermined time period corresponding to said delay time (for example in the range of a few ten seconds, for example thirty seconds), without step 203 of emitting a reactivation request being necessary.

According to a particular feature, the emission by the communication terminal TC of a request for reactivating at least one first frequency band at step 201 (respectively for reactivating at least one first frequency band at step 203) is optionally followed by the reception from the gateway GW of a message confirming said deactivation, in a step 202 (respectively confirming said reactivation, in a step 204).

### Second Embodiment—Transmission in the AP Mode

Referring to FIG. 3, another particular embodiment of the method according to the present technique is now described, wherein step 103 of transmitting connection information on connection to the WiFi network RES from the communication terminal TC to the communicating object OC is implemented by means of a direct WiFi communication channel established between the communication terminal TC and the WiFi communicating object configured beforehand as a WiFi access point (case of a transmission in the AP mode). Steps 101 and 102 of obtaining the connection information remain identical to those already described with reference to FIG. 1.

In this particular embodiment, before transmitting the connection information, the communication terminal emits, in a step 301, a network scan request, to the gateway GW (thereby resorting for example to a third application programming interface provided for this purpose at the level of the gateway GW).

In response to this request, the communication terminal TC receives, from the gateway GW, in a step 302, a list of WiFi networks detected by the gateway GW during said network scan. The communicating object having been configured beforehand as a WiFi access point, the received list typically comprises at least one entry corresponding to the WiFi network associated to said communicating object OC, comprising at least the name (i.e. the SSID) of said network (provided that the communicating object OC is not too much far away from the gateway GW).

In the context of the present technique, such a list may be exploited in different manners.

In a particular embodiment, the list received by the communication terminal TC is for example completely displayed within a graphical interface generated by the application APP, in a form enabling the user of the communication terminal to browse in the displayed list and select an element therein. In this manner, without quitting the application APP, the user has access to the list of WiFi networks detected in the proximity of the gateway GW (and therefore in the proximity of the communication terminal TC), including the WiFi network created by the communicating object OC as an access point. For example, the displayed list comprises the name (SSID) of the different wireless networks detected by the gateway GW during the performed network scan.

According to other embodiments, mechanisms are provided for to enable filtering he list received in step 302, in order to either limit the number of networks proposed to the user as being likely to correspond to the WiFi network generated by communicating object OC and displayed as such within a graphical interface generated by the application APP, or proceed with an automatic selection by the application APP (i.e. without any intervention of the user) of the network considered as having the highest probability of corresponding to the WiFi network generated by the communicating object OC.

According to a particular feature, to limit the list of the detected networks to the WiFi networks having the highest probability of corresponding to a WiFi network generated by a communicating object, the request emitted at step 301 may comprise a parameter specifying a WiFi frequency band to be used for said scan, typically the 2.4 GHz frequency band used by most communicating object currently available on the market.

Complementarily or alternatively, it is also possible to filter the list of detected networks based on their names (SSID). Indeed, it is frequent that the name of a network associated to a communicating object complies with a known particular format, that is possible to save beforehand in the application APP, for example in the form of a name mask. For example, a portion of the name of a network associated to a communicating object (often a first portion of this name) generally comprises the name of the manufacturer of the communicating object and/or the name of the model of the communicating object. According to a particular feature of the proposed technique, the application APP then implements a step of identifying, within the list of detected WiFi networks, at least one WiFi network whose name meets the criteria of a predetermined name mask stored in said application APP, thereby allowing performing a first filtering. If it contains several elements, the list thus filtered is displayed for example within a graphical interface generated by the application APP, in a form enabling the user of the communication terminal to browse in the displayed list and select an element therein. However, if the filtered list contains only one element, in other words when said identification step delivers a unique result, it is not necessary to display this element within a graphical interface of the application APP: indeed, the network identified in a unique way then corresponds very likely to the network associated to the communicating object OC, and it can be automatically selected by the application APP without any intervention of the user. Although this is not necessary, the unique result may be displayed within the graphical interface of the application APP.

In any event, whether automatically or consecutively to a selection of the user via a dedicated graphical interface of the application APP, the communication terminal proceeds, in a step 303, with the selection, within the list received in step 302, of a network corresponding to the network associated to the communicating object OC configured as a WiFi access point

Once this WiFi network of the communicating object OC is identified and selected by means of the application APP, a step 304 of connecting the communication terminal TC to this network is implemented, thereby enabling the establishment of the direct WiFi communication channel between the communication terminal TC and the communicating object OC (i.e. via the connection of the communication terminal TC to the WiFi network created by the communicating object OC). It should be noted herein that step 304 is carried out without the user having to quit the application APP. More particularly, it is suggested to exploit the possibility offered by the operating systems of current mobile communication terminals to authorise an application to trigger a connection of the communication terminal to a WiFi network provided that this application has access to the name of the considered WiFi network (i.e. its SSID) (which is the case herein for the application APP, thanks to the prior implementation of steps 301 and 302). By requesting from the gateway GW to proceed on its own with the network scan, the present technique allows circumventing, in an ingenious way, the restriction, also imposed by the operating systems of current mobile communication terminals, according to which an application is not authorised to perform on its own a network scan intended to detect the different WiFi networks available nearby. In other words, the results of a network scan performed at the level of the gateway GW and “pushed” towards the application APP of the communication terminal TC are advantageously used herein, rather than the results of a network scan performed by the communication terminal TC itself, which would have imposed on the user to quit the application APP (or to the very least to toggle it in the background) in order to browse in the native screens and the system parameters of the communication terminal, and which would have rendered the user experience particularly complex and much less intuitive. Thus, with the proposed technique, the user is at the most invited to validate a very restricted number of messages (and possibly enter a password associated to the WiFi network generated by the communicating object OC, if such a password is required) automatically displayed by the system directly within the application APP. Thus, the user experience is perfectly guided, and the user does not have to browse by himself freely in system native screens to try to discover by himself the configuration parameters to be modified (thereby avoiding the risks of getting lost when browsing in these screens and/or modifying wrong configuration parameters).

According to a particular feature, the list of WiFi networks received by the communication terminal TC at step 302 comprises, for each detected network present in said list, besides the SSID, an indicative value of a receive power level (RSSI, or “Received Signal Strength Indicator”) associated to said network, at the level of the gateway GW. Such a value is interesting in that it enables the user to estimate, to some extent, the distance, from the gateway GW, of the piece of equipment at the origin of the received WiFi signal (to the very least in a relative manner, in comparison with the RSSI values associated to each detected WiFi network). In particular, such data may be used to facilitate the identification of the WiFi network associated to the communicating object that the user wishes to add to his local network. For example, this data may be used to classify the list of detected networks when displaying this list within a graphical interface of the application APP (for example, by increasing or decreasing RSSI).

According to a particular feature, the sequence of emitting 301 a network scan request and of receiving 302 a reply comprising a list of Wifi networks with associated RSSI is implemented several times (i.e. at least twice), and a message inviting the user to bring the communicating object WiFi OC he wishes to add to his network away from or close to the gateway GW is displayed in the application APP between each sequence. In this manner, by comparing, for each detected Wifi network, the receive power level indicative values obtained during several successive iterations of the aforementioned sequences, the application APP is able to identify the WiFi networks associated to equipment whose position seems to have varied between two sequences, and thus automatically select, or to the very least highlight, amongst the list of detected networks, according to the result of said comparison, the WiFi network having the highest probability of corresponding to the WiFi network provided by the communicating object OC (ambiguity clear-up mechanism).

Complementarily or alternatively, according to a relatively similar principle, the sequence of emitting 301 a network scan request and of receiving 302 a reply comprising a list of Wifi networks is implemented at least twice, and a message inviting the user to toggle the WiFi communicating object he wishes to add to his network from a state where it is not configured as a WiFi access point into a state in which it is configured as a WiFi access point is displayed in the application APP between two sequences. In this manner, by comparing, for each detected Wifi network, the lists of detected networks upon several successive iterations of the aforementioned sequences, the application APP is able to identify the WiFi networks that have not been detected during a first sequence but detected during a subsequent sequence, and thus automatically select, or to the very least highlight, amongst the list of detected networks, according to the result of said comparison, the WiFi network having the highest probability of corresponding to the WiFi network provided by the communicating object OC (ambiguity clear-up mechanism).

### Devices

According to another aspect, the proposed technique also relates to a communication terminal able to carry out the previously-described method in any one of its embodiments, for the implementation of a simplified addition of a WiFi communicating object to a WiFi wireless local network provided by a gateway. More particularly, the communication terminal according to the present technique comprises:
means for emitting, to said gateway, a request for obtaining at least one piece of information on connection to said network;
means for receiving, from said gateway, said at least one piece of information on connection to said network;
means for transmitting, to said WiFi communicating object, said at least one piece of information on connection to said network.

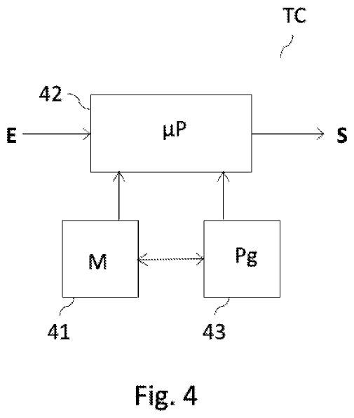

FIG. 4 represents, in a schematic and simplified manner, the structure of such a communication terminal, in a particular embodiment. For example, the communication terminal according to the proposed technique comprises a memory 41 consisting of a buffer memory M, a processing unit 42, equipped for example with a microprocessor μP, and controlled by the computer program Pg 43, implementing steps of the method for adding a communicating object to a wireless local network according to at least one embodiment of the development. To this end, the communication terminal also comprises at least one communication interface (for example a WiFi communication interface), enabling it to connect to a wireless communication local network (for example a WiFi network) provided by a gateway-type device or by a communicating object.

Upon initialisation, the computer program code instructions 43 are loaded in the buffer memory before being executed by the processor of the processing unit 42. The processing unit 42 receives as input E for example signals delivered in response to actions of a user on an application dedicated to the addition of communicating objects to a WiFi network, executed by the communication terminal.

The microprocessor of the processing unit 42 then carries out the steps of the addition method, according to the instructions of the computer program 43. More particularly, depending on the signals received at the input E, the processing unit 42 emits one or more request(s) to a gateway providing a wireless communication local network to which the communication terminal is connected, according to a predefined format consistent with application programming interfaces exposed by said gateway. Afterwards, the replies to these requests are processed by the processing unit 42, to end up at the output S with a transmission of connection information to a communicating object, enabling the latter to subsequently establish a wireless connection to said network.

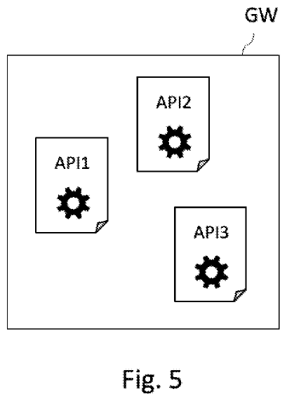

According to another aspect, the proposed technique also relates to a gateway GW as schematically illustrated with reference to FIG. 5, in a particular embodiment. Such a gateway GW comprises at least one communication interface enabling it to generate a wireless local network (for example a WiFi communication interface enabling it to generate a WiFi network), and a set of application programming interfaces allowing providing services to communication terminals, on request. More particularly, the gateway GW according to the present technique comprises at least one first application programming interface API1 which obtains, on request of a communication terminal (so-called requesting terminal) connected to the wireless network (for example to the WiFi network) provided by said gateway, at least one connection piece of information allowing establishing a connection to said network, and which returns to the requesting terminal a reply comprising said at least one connection piece of information.

In a particular embodiment of the present technique, the gateway GW also complementarily comprises:
a second application programming interface API2 which implements, on request of a communication terminal connected to said gateway, the deactivation or the reactivation at the level of said gateway of at least one frequency band (the frequency band to be deactivated or reactivated being for example identified in the request); and/or
a third application programming interface API3 which implements, on request of a communication terminal (called requesting terminal) connected to said gateway, at the level of said gateway, a network scan for detecting wireless networks (for example WiFi networks), and which returns to said requesting terminal a reply comprising the list of the networks detected in the vicinity of said gateway (for example in the form of a SSID list) and possibly, optionally, for each detected WiFi network, an indicative value of a receive power level (RSSI) associated to said network.

As detailed in connection with the various disclosed particular embodiments, the implementation within a gateway of application programming interfaces as described before enables the implementation, at the level of a communication terminal connected to said gateway, of a method for adding a communicating object to a wireless local network (for example a WiFi network) which offers many advantages compared to existing solutions. The features disclosed in the different described embodiments can be combined without departing from the scope of the present technique, the embodiment covering a transmission in the AP mode for example possibly being implemented after that one covering a transaction in the EZ mode, as a backup solution if the communicating object does not succeed, for any reason, to connect to the wireless communication network provided by the gateway after implementation of the first embodiment.

1. A method for adding a communicating object to a wireless communication local network provided by a gateway, the method being implemented within a dedicated application executed on a communication terminal connected to the network via the gateway, wherein the method comprises:
emitting, to the gateway, a request for obtaining at least one piece of information on connection to the network;
receiving from the gateway, the at least one piece of information on connection to the network; and
transmitting, to the communicating object, the at least one piece of information on connection to the network.

2. The method according to claim 1, comprising, prior to the transmitting, emitting, to the gateway, at least one request for implementing by the gateway at least one operation amongst a frequency deactivation operation and a frequency scan operation, the request comprising at least one frequency band piece of information.

3. The method according to claim 2, wherein the request for obtaining at least one piece of information on connection to the network, the request for implementing a frequency deactivation operation, and the request for implementing a frequency scan operation are respectively formatted in accordance with first, second and third application programming interfaces exposed by the gateway for the supply of corresponding services to the communication terminal.

4. The method according to claim 1, wherein the transmitting is implemented by disseminating the connection information, and in that the method comprises, prior to the transmitting, emitting, to the gateway, a request for deactivating at least one first frequency band at the level of the gateway, the deactivation causing an automatic toggling of the communication terminal into a communication mode using a second frequency band other than the at least one first deactivated first frequency band at the level of the gateway, for the transmission by dissemination.

5. The method according to claim 4, wherein the request for deactivating at least one first frequency band is a request for deactivating at least one amongst the frequency bands 5 GHz and 6 GHz.

6. The method according to claim 4, comprising, subsequently to the transmitting, emitting, to the gateway, a request for reactivating, at the level of the gateway, the at least one first frequency band previously deactivated.

7. The method according to claim 1, wherein the transmitting of the connection information is implemented by means of a direct communication channel established between the communication terminal and the communicating object configured beforehand as an access point, wherein the method comprises the following, implemented prior to the transmitting:
emitting, to the gateway, a network scan request;
receiving, from the gateway, a list of networks detected by the gateway during the network scan;
selecting, within the list, a network corresponding to the network associated to the communicating object configured as an access point; and
establishing the direct communication channel between the communication terminal and the communicating object, by connection of the communication terminal to the selected network.

8. The method according to claim 7, wherein the network scan request comprises a frequency band piece of information to be used for the network scan.

9. The method according to claim 7, comprising:
identifying, within the list of detected networks, at least one network whose name meets the criteria of a predetermined name mask stored in the dedicated application;
and, when the identification delivers a unique result, in that the selection comprises the automatic selection of the network identified in a unique way.

10. The method according to claim 7, wherein the list comprises a receive power level indicative value associated to each detected network.

11. The method according to claim 10, wherein the emitting a network scan request and of receiving a list of networks in response to the scan request are implemented at least twice, and in that the method comprises:
displaying, between two iterations of the emitting a network scan request and of receiving a list of networks in response to the scan request, an invitation to bring the communicating object away from or close to the gateway;
comparing, for each detected network, receive power level indicative values obtained during each of the iterations; and
automatically selecting or highlighting within a graphical interface associated to the application, amongst the list of detected networks, according to the result of the comparison, a network having the highest probability of corresponding to the network provided by the communicating object configured as an access point.

12. The method according to claim 7, wherein the emitting a network scan request and of receiving a list of networks in response to the scan request are implemented at least twice, and in that the method comprises:
displaying, between two iterations of the emitting a network scan request and of receiving a list of networks in response to the scan request, an invitation to toggle the communicating object into an access point configuration;
comparing the lists of detected networks during each of the iterations; and
automatically selecting or highlighting within a graphical interface associated to the application, amongst the list of detected networks, according to the result of the comparison, a network having the highest probability of corresponding to the network provided by the communicating object configured as an access point.

13. A communication terminal for the implementation of an addition of a communicating object to a wireless local network provided by a gateway, the communication terminal comprising:
an emitter, configured to emit to the gateway, a request for obtaining at least one piece of information on connection to the network;
a receiver, configured to receive from the gateway, the at least one piece of information on connection to the network; and
a transmitter, configured to transmit to the communicating object, the at least one piece of information on connection to the network.

14. A gateway for providing a wireless local network, the gateway comprising a set of application programming interfaces for providing at least one service to a communication terminal connected to the network via the gateway, on request of the communication terminal, referred to as a requesting terminal, the set of application programming interfaces comprising:
a first application programming interface for obtaining at least one piece of information on connection to the network, and for providing the connection information to the requesting terminal;
a second application programming interface for deactivation/reactivation of at least one frequency band at the level of the gateway; and
a third application programming interface for implementing a network scan and for providing the requesting terminal with a list of networks detected during the network scan.

15. A non-transitory computer storage medium, storing program code instructions of a computer program downloadable from a communication network causing execution of the method according to claim 1, when the computer program is executed by a computer.
